(19) United States
(12) Patent Application Publication
(10) Pub. No.: US 2026/0316844 A1
(43) Pub. Date: Oct. 15, 2026

(54) Fender Coupling System

(71) Applicant: Lyndon Johnson, Breezy Point, MN (US)

(72) Inventor: Lyndon Johnson, Breezy Point, MN (US)

(21) Appl. No.: 19/175,133

(22) Filed: Apr. 10, 2025

(51) Int. Cl. B62D 25/16

(52) U.S. Cl. CPC B62D 25/163

(57) ABSTRACT

A fender coupling assembly for a steerable lift axle includes a vehicle having a steerable lift axle that is coupled to a wheel. The steerable lift axle is upwardly and downwardly movable wherein the steerable lift axle is designed for selectively adjusting a position of the wheel relative to a surface on which the vehicle is driving. A plate bracket is couplable to the steerable lift axle wherein the plate bracket is raised and lowered when the steerable lift axle selectively raises and lowers the wheel. An arm is coupled to and extends from the plate bracket. A fender is coupled to the arm wherein the arm secures the fender to the plate bracket for positioning the fender above the wheel. A brake assembly is coupled to the steerable lift axle wherein the plate bracket is positionable between the brake assembly and the wheel.

### (A) TITLE OF THE INVENTION

FENDER COUPLING ASSEMBLY

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to fenders and more particularly pertains to a new fender for a steerable lift axle.

### (2) Description of Related Art Including Information Disclosed Under 37 CFR 1.97 and 1.98

The prior art relates to fenders, particularly fenders on steerable lift axles. Fenders on steerable lift axles must be securely mounted while accommodating the dynamic movement of the axle. Unlike fixed axles, steerable lift axles raise and lower based on load requirements and pivot for improved maneuverability, making fender attachment more complex. Typically, attachment of the fender requires dismantling the wheel and the brake assembly from the steerable lift axle. Often, pieces need to be specially manufactured to work fit correctly with each particular model of steerable lift axle and brake assembly. This process is time consuming and labor intensive. Thus, there is a need for an improved device for attaching a fender to a steerable lift axle. Ideally, such a device could be installed without removing both the wheel and the brake assembly, and would work universally with most, or all, types of steerable lift axles.

### (h) BRIEF SUMMARY OF THE INVENTION

An embodiment of the disclosure meets the needs presented above by generally comprising a vehicle having a steerable lift axle that is coupled to a wheel. The steerable lift axle is upwardly and downwardly movable wherein the steerable lift axle is designed for selectively adjusting a position of the wheel relative to a surface on which the vehicle is driving. A plate bracket is couplable to the steerable lift axle wherein the plate bracket is raised and lowered when the steerable lift axle selectively raises and lowers the wheel. An arm is coupled to and extends from the plate bracket. A fender is coupled to the arm wherein the arm secures the fender to the plate bracket for positioning the fender above the wheel. A brake assembly is coupled to the steerable lift axle wherein the plate bracket is positionable between the brake assembly and the wheel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a fender coupling assembly according to an embodiment of the disclosure.

FIG. 2 is a side view of an embodiment of the disclosure.

FIG. 3 is a top view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

FIG. 7 is a front in-use view of an embodiment of the invention.

### (j) DETAILED DESCRIPTION OF THE INVENTION

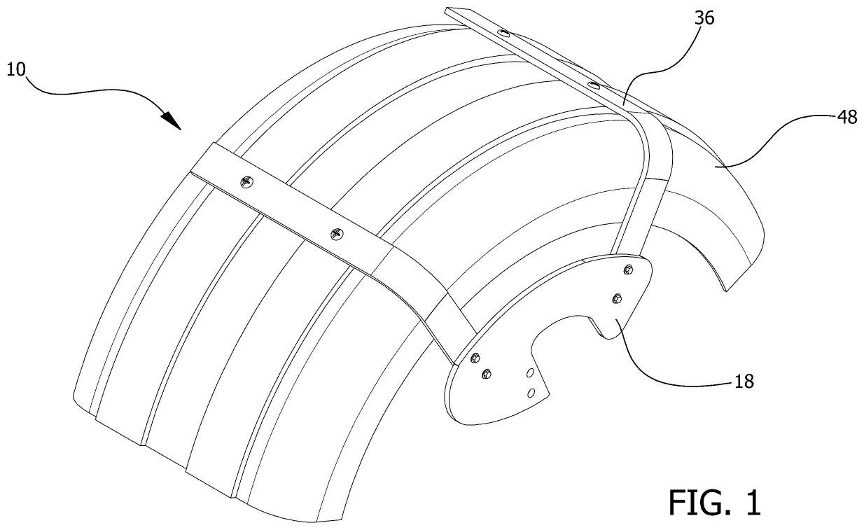

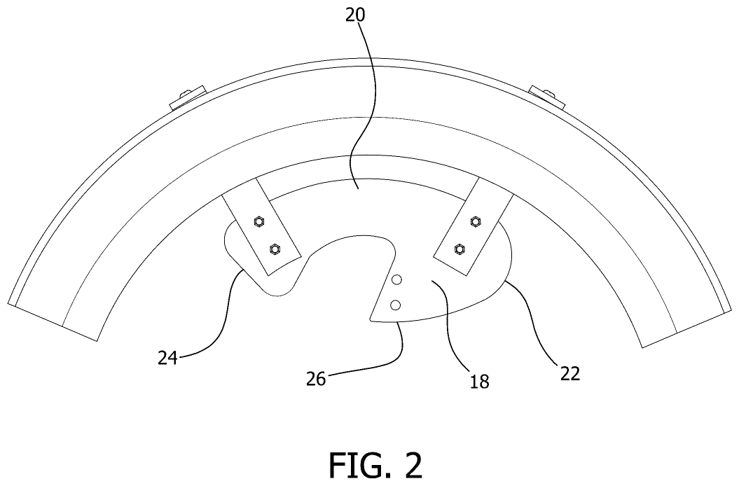

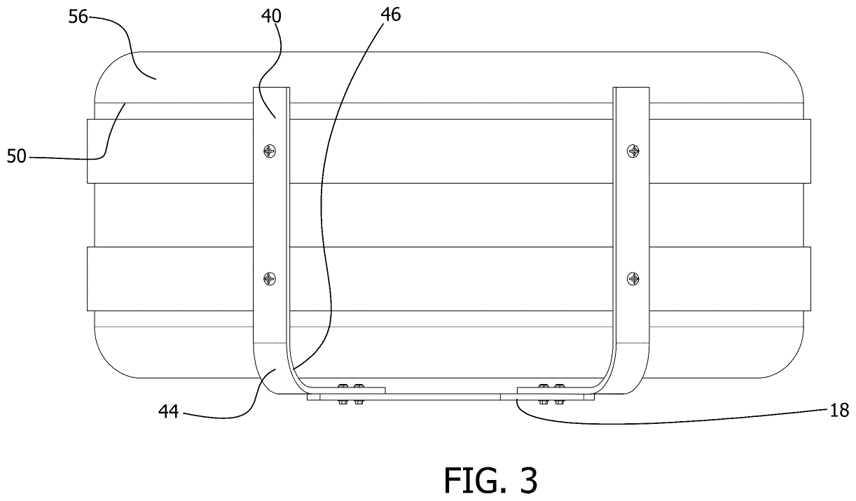

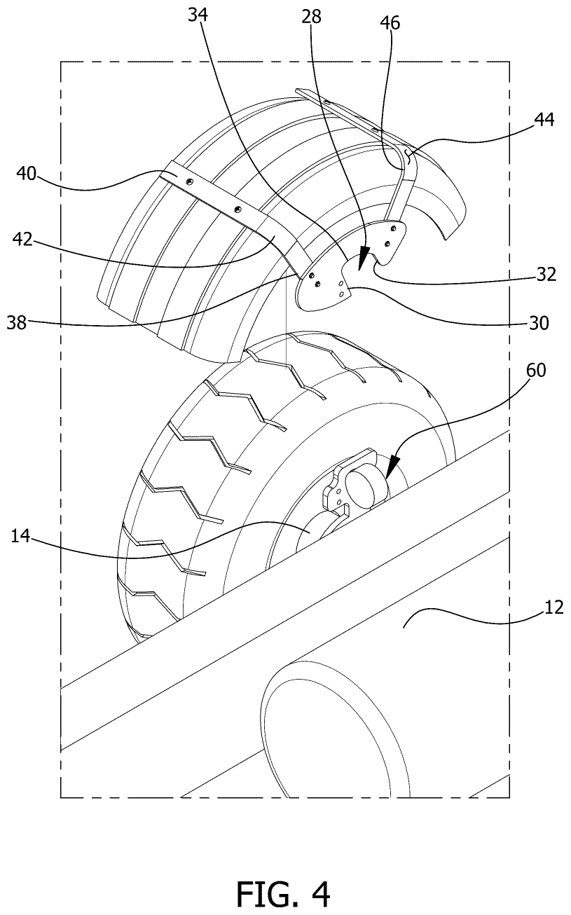

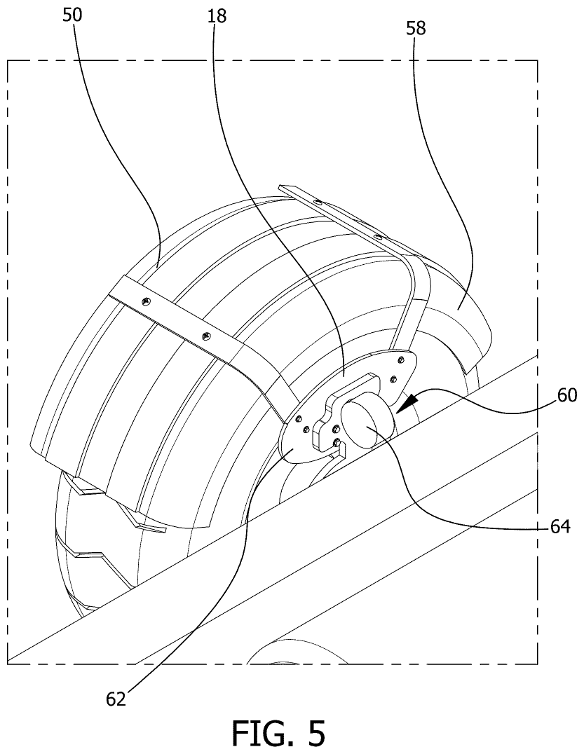

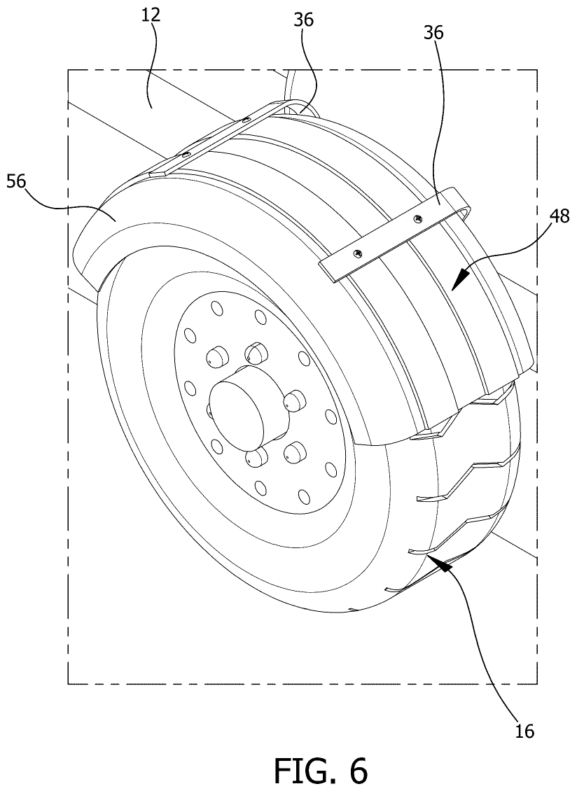

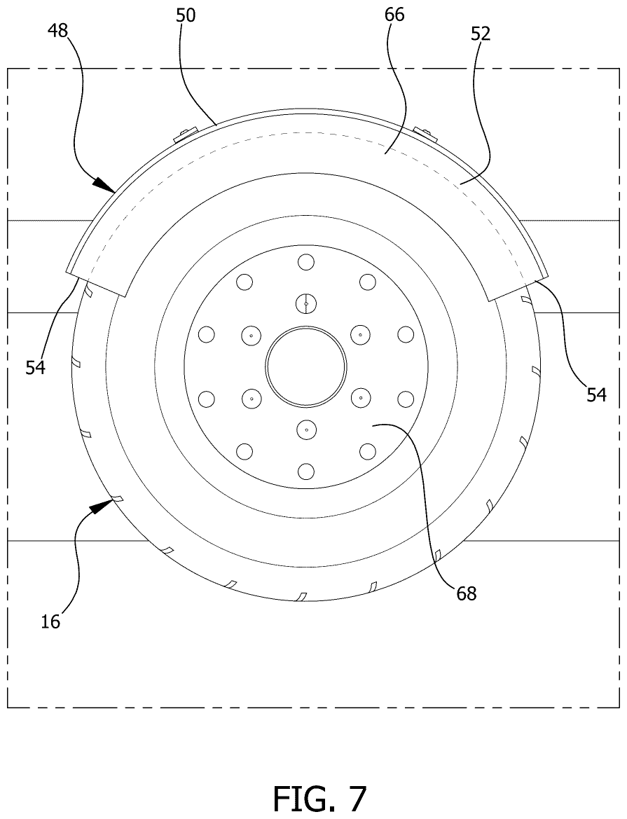

With reference now to the drawings, and in particular to FIGS. 1 through 7 thereof, a new fender embodying the principles and concepts of an embodiment of the disclosure and generally designated by the reference numeral 10 will be described.

As best illustrated in FIGS. 1 through 7, the fender coupling assembly 10 generally comprises A vehicle 12 having a steerable lift axle 14 is coupled to a wheel 16. The wheel 16 includes a tire 66 positioned around a hub 68. The steerable lift axle 14 is upwardly and downwardly movable wherein the steerable lift axle 14 is configured for selectively adjusting a position of the wheel 16 relative to a surface on which the vehicle 12 is driving.

A plate bracket 18 is couplable to the steerable lift axle 14 wherein the plate bracket 18 is raised and lowered when the steerable lift axle 14 selectively raises and lowers the wheel 16. The plate bracket 18 is made from a rigid material wherein the rigid material is configured to inhibit damage of the plate bracket 18. Examples of the rigid material may include metal or plastic and should be rigid enough to inhibit the plate bracket 18 from bending, chipping, denting, breaking, deforming, or otherwise being damaged when debris (such as rocks, sticks, or cement) impacts the plate bracket 18 as the vehicle 12 is driven along the surface.

The plate bracket 18 has a top edge 20. A first side edge 22 is coupled to and extends from the top edge 20. A second side edge 24 is coupled to and extends from the top edge 20. The second side edge 24 is distally positioned on the top edge 20 relative to the first side edge 22. The top edge 20 may be convexly arcuate between the first side edge 22 and the second side edge 24. A bottom edge 26 is coupled to and extends between the first side edge 22 and the second side edge 24. The bottom edge 26 is distally positioned on each of the first side edge 22 and the second side edge 24 relative to the top edge 20. The second side edge 24 may be angled to extend downwardly from the top edge 20 and inwardly to the bottom edge 26 wherein the bottom edge 26 has a length that is less than a length of the top edge 20.

A cutout 28 extends upwardly through the bottom edge 26 toward the top edge 20 of the plate bracket 18. The cutout 28 may be spaced from the first side edge 22 by a distance exceeding a distance between the cutout 28 and the second side edge 24. A primary peripheral boundary 30 of the cutout 28 may be angled to extend upwardly from the bottom edge 26 of the plate bracket 18 toward the first side edge 22. A secondary peripheral boundary 32 may extend upwardly from the bottom edge 26 of the plate bracket 18. The secondary peripheral boundary 32 may be parallel to the primary peripheral boundary 30. An upper boundary 34 may be concavely arcuate between the primary peripheral boundary 30 and the secondary peripheral boundary 32. The upper boundary 34 is spaced from the top edge 20 of the plate bracket 18.

An arm 36 is coupled to and extends from the plate bracket 18. In some embodiments, a pair of arms 36 may be coupled to the plate bracket 18. The arm 36, or each arm of the pair of arms 36 may include a lower rib 38 that extends upwardly relative to the top edge 20 of the plate bracket 18. The lower rib 38 of each arm of the pair of arms 36 may be angled to extend upwardly from the top edge 20 and outwardly toward a respective one of the first side edge 22 and the second side edge 24 wherein the pair of arms 36 are angled to extend outwardly relative to each other.

An upper rib 40 may be angled to extend outwardly from the lower rib 38 and upwardly relative to the top edge 20 of the plate bracket 18. The upper rib 40 generally has a length exceeding a length of the lower rib 38. A central rib 42 may be coupled to and extend between the upper rib 40 and the lower rib 38. The central rib 42 may have an upper surface 44 that is convexly arcuate between the lower rib 38 and the upper rib 40. A lower surface 46 may be concavely arcuate between the lower rib 38 and the upper rib 40.

A fender 48 may be coupled to the arm 36, or the pair of arms 36, to secure the fender 48 to the plate bracket 18 for positioning the fender 48 above the wheel 16. Because the plate bracket 18, and thus the pair of arms 36, are selectively raised and lowered with the steerable lift axle 14, the fender 48 is also selectively raised and lowered. A distance between the fender 48 and the wheel 16 is therefore consistent and unchanged as the wheel 16 is raised and lowered.

The fender 48 may include an upward facing surface 50 that faces upwardly away from the wheel 16 while the plate bracket 18 is coupled to the steerable lift axle 14. The upper rib 40 of each arm of the pair of arms 36 may have a length that is equal to, or greater than, a width of the upward facing surface 50 wherein the pair of arms 36 extend between opposing ends of the upward facing surface 50.

A downward facing surface 52 may face downwardly toward the wheel 16 while the plate bracket 18 is coupled to the steerable lift axle 14. The downward facing surface 52 is spaced from the tire 66 of the wheel 16 to facilitate rotation of the wheel 16 beneath the fender 48. In other words, the fender 48 is vertically spaced from the tire 66 of the wheel 16 to inhibit friction between the fender 48 and the tire 66 from affecting rotation of the wheel 16.

A pair of lateral ends 54 of the fender 48 are distally positioned relative to each other on each of the upward facing surface 50 and the downward facing surface 52. The upward facing surface 50 is generally convexly arcuate between the pair of lateral ends 54. The upper rib 40 of each arm of the pair of arms 36 is generally positionable flush against the upward facing surface 50. An outward facing surface 56 faces outwardly away from the steerable lift axle 14 while the plate bracket 18 is coupled to the steerable lift axle 14. The outward facing surface 56 generally extends downwardly from the upward facing surface 50.

An inward facing surface 58 may face inwardly toward the steerable lift axle 14 while the plate bracket 18 is coupled to the steerable lift axle 14. The inward facing surface 58 may have a curvature that is complementary to a curvature of the lower surface 46 of the central rib 42 of the pair of arms 36 wherein the inward facing surface 58 is positioned flush against the lower surface 46 of the central rib 42 of the pair of arms 36. The inward facing surface 58 extends downwardly from the upward facing surface 50.

A brake assembly 60 is coupled to the steerable lift axle 14. The plate bracket 18 is positionable between the brake assembly 60 and the wheel 16. Accordingly, the plate bracket 18 may be configured to inhibit debris from contacting the brake assembly 60. The brake assembly 60 is actuatable to inhibit movement of the wheel 16 coupled to the steerable lift axle 14. For example, the brake assembly 60 may have a projection 62 that is couplable to the plate bracket 18. The projection 62 may extend upwardly from the steerable lift axle 14. An air cannister 64 may be coupled to and extend outwardly from the projection 62 wherein the air cannister 64 is positioned between a body of the vehicle 12 and the projection 62. The air cannister 64 is positionable within the cutout 28.

In use, the wheel 16 can be removed from the steerable lift axle 14, exposing the brake assembly 60. More specifically, the tire 66 can be removed while the hub 68 of the wheel 16 remains coupled to the steerable lift axle 14. The plate bracket 18 can be attached to the projection 62 of the brake assembly 60, with the air cannister 64 positioned within the cutout 28. Once the wheel 16 is re-attached to the steerable lift axle 14, the pair of arms 36 will suspend the fender 48 above the wheel 16. The plate bracket 18 can be positioned on either side of the vehicle 12, facilitating easy installation of the fender 48 on either side of the steerable lift axle 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fender attachment system comprising:
a vehicle having a steerable lift axle being coupled to a wheel, the steerable lift axle being upwardly and downwardly movable wherein the steerable lift axle is configured for selectively adjusting a position of the wheel relative to a surface on which the vehicle is driving;
a plate bracket being couplable to the steerable lift axle wherein the plate bracket is raised and lowered when the steerable lift axle selectively raises and lowers the wheel;
an arm being coupled to and extending from the plate bracket;
a fender being coupled to the arm wherein the arm secures the fender to the plate bracket for positioning the fender above the wheel; and
a brake assembly being coupled to the steerable lift axle wherein the plate bracket is positionable between the brake assembly and the wheel.

2. The fender attachment system of claim 1, wherein the plate bracket is made from a rigid material wherein the rigid material is configured to inhibit damage of the plate bracket.

3. The fender attachment system of claim 1, the plate bracket further comprising:
a top edge;
a first side edge being coupled to and extending from the top edge;
a second side edge being coupled to and extending from the top edge; and
a bottom edge being coupled to and extending between the first side edge and the second side edge.

4. The fender attachment system of claim 3, wherein the top edge is convexly arcuate between the first side edge and the second side edge.

5. The fender attachment system of claim 3, wherein the second side edge is angled to extend downwardly from the top edge and inwardly to the bottom edge wherein the bottom edge has a length being less than a length of the top edge.

6. The fender attachment system of claim 1, further comprising a cutout extending through the plate bracket.

7. The fender attachment system of claim 6, the cutout further comprising:
a primary peripheral boundary being angled to extend upwardly from a bottom edge of the plate bracket;
a secondary peripheral boundary extending upwardly from the bottom edge of the plate bracket; and
an upper boundary being concavely arcuate between the primary peripheral boundary and the secondary peripheral boundary.

8. The fender attachment system of claim 7, wherein the secondary peripheral boundary is parallel to the primary peripheral boundary.

9. The fender attachment system of claim 7, wherein the upper boundary of the cutout is spaced from a top edge of the plate bracket.

10. The fender attachment system of claim 7, the brake assembly further comprising:
a projection being couplable to the plate bracket, the projection extending upwardly from the steerable lift axle; and
an air cannister being coupled to and extending outwardly from the projection, the air cannister being positionable within the cutout.

11. The fender attachment system of claim 1, wherein the arm is one of a pair of arms.

12. The fender attachment system of claim 11, each arm of the pair of arms further comprising:
a lower rib extending upwardly relative to the plate bracket, the lower rib of each arm of the pair of arms being angled to extend upwardly from the top edge and outwardly relative to each other;
an upper rib being angled to extend outwardly from the lower rib and upwardly relative to the plate bracket; and
a central rib being coupled to and extending between the upper rib and the lower rib, the central rib including:
an upper surface being convexly arcuate between the lower rib and the upper rib; and
a lower surface being concavely arcuate between the lower rib and the upper rib wherein the lower surface is positionable against an upward facing surface of the fender, the upward facing surface facing upwardly away from the wheel.

13. The fender attachment system of claim 12, wherein the upper rib has a length exceeding a length of the lower rib.

14. The fender attachment system of claim 1, the arm further comprising:
a lower rib extending upwardly relative to the plate bracket;
an upper rib being angled to extend outwardly from the lower rib and upwardly relative to the plate bracket; and
a central rib being coupled to and extending between the upper rib and the lower rib, the central rib including:
an upper surface being convexly arcuate between the lower rib and the upper rib; and
a lower surface being concavely arcuate between the lower rib and the upper rib wherein the lower surface is positionable against an upward facing surface of the fender, the upward facing surface facing upwardly away from the wheel.

15. A fender attachment system comprising:
a vehicle having a steerable lift axle being coupled to a wheel, the steerable lift axle being upwardly and downwardly movable wherein the steerable lift axle is configured for selectively adjusting a position of the wheel relative to a surface on which the vehicle is driving;
a plate bracket being couplable to the steerable lift axle wherein the plate bracket is raised and lowered when the steerable lift axle selectively raises and lowers the wheel, the plate bracket being made from a rigid material wherein the rigid material is configured to inhibit damage of the plate bracket, the plate bracket including:
a top edge;
a first side edge being coupled to and extending from the top edge;
a second side edge being coupled to and extending from the top edge, the second side edge being distally positioned on the top edge relative to the first side edge, the top edge being convexly arcuate between the first side edge and the second side edge;
a bottom edge being coupled to and extending between the first side edge and the second side edge, the bottom edge being distally positioned on each of the first side edge and the second side edge relative to the top edge, the second side edge being angled to extend downwardly from the top edge and inwardly to the bottom edge wherein the bottom edge has a length being less than a length of the top edge;
a cutout extending upwardly through the bottom edge toward the top edge of the plate bracket, the cutout being spaced from the first side edge by a distance exceeding a distance between the cutout and the second side edge, the cutout including:
a primary peripheral boundary being angled to extend upwardly from the bottom edge of the plate bracket toward the first side edge;
a secondary peripheral boundary extending upwardly from the bottom edge of the plate bracket, the secondary peripheral boundary being parallel to the primary peripheral boundary; and
an upper boundary being concavely arcuate between the primary peripheral boundary and the secondary peripheral boundary, the upper boundary being spaced from the top edge of the plate bracket;
a pair of arms being coupled to the plate bracket, each arm of the pair of arms including:
a lower rib extending upwardly relative to the top edge of the plate bracket, the lower rib of each arm of the pair of arms being angled to extend upwardly from the top edge and outwardly toward a respective one of the first side edge and the second side edge wherein the pair of arms are angled to extend outwardly relative to each other;
an upper rib being angled to extend outwardly from the lower rib and upwardly relative to the top edge of the plate bracket, the upper rib having a length exceeding a length of the lower rib; and
a central rib being coupled to and extending between the upper rib and the lower rib, the central rib including:
an upper surface being convexly arcuate between the lower rib and the upper rib; and
a lower surface being concavely arcuate between the lower rib and the upper rib;
a fender being coupled to the pair of arms wherein the pair of arms secure the fender to the plate bracket for positioning the fender above the wheel being coupled to the steerable lift axle, the fender including:
an upward facing surface facing upwardly away from the wheel while the plate bracket is coupled to the steerable lift axle;
a downward facing surface facing downwardly toward the wheel while the plate bracket is coupled to the steerable lift axle;
a pair of lateral ends being distally positioned relative to each other on each of the upward facing surface and the downward facing surface, the upward facing surface being convexly arcuate between the pair of lateral ends wherein the upper rib of each arm of the pair of arms is positionable flush against the upward facing surface;
an outward facing surface facing outwardly away from the steerable lift axle while the plate bracket is coupled to the steerable lift axle, the outward facing surface extending downwardly from the upward facing surface; and
an inward facing surface facing inwardly toward the steerable lift axle while the plate bracket is coupled to the steerable lift axle, the inward facing surface having a curvature being complementary to a curvature of the lower surface of the central rib of the pair of arms wherein the inward facing surface is positioned flush against the lower surface of the central rib of the pair of arms, the inward facing surface extending downwardly from the upward facing surface; and
a brake assembly being coupled to the steerable lift axle wherein the plate bracket is positionable between the brake assembly and the wheel whereby the plate bracket is configured to inhibit debris from contacting the brake assembly, the brake assembly being actuatable to inhibit movement of the wheel coupled to the steerable lift axle, the brake assembly including:
a projection being couplable to the plate bracket, the projection extending upwardly from the steerable lift axle; and
an air cannister being coupled to and extending outwardly from the projection wherein the air cannister is positioned between a body of the vehicle and the projection, the air cannister being positionable within the cutout.
